(19) United States
(12) Patent Application Publication
(10) Pub. No.: US 2007/0159047 A1
(43) Pub. Date: Jul. 12, 2007

(54) Spark plug having excellent capabilities of detecting ion current and suppressing inside sparks

(75) Inventor: Teiji Ishinada, Chiryu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/645,631

(22) Filed: Dec. 27, 2006

(30) Foreign Application Priority Data
Jan. 10, 2006 (JP) 2006-002602

(51) Int. Cl. H01T 13/20

(52) U.S. Cl. 313/143

(57) ABSTRACT

According to the present invention, there is provided a spark plug for an internal combustion engine which includes a tubular metal shell, an insulator, a center electrode, and a ground electrode. In the spark plug, L1, which is the sum of lengths of an intermediate portion and a second outer shoulder of the insulator in the longitudinal direction of the insulator, is greater than or equal to 10 mm; the intermediate portion of the insulator has an outer surface that includes a first and a second section and has an electrically conductive coat only on the second section; and the first section of the outer surface of the intermediate portion of the insulator has a length in the longitudinal direction of the insulator in a range of 1 to 8 mm. With such a configuration,

### CROSS-REFERENCE TO RELATED APPLICATION

This application is based on and claims priority from Japanese Patent Application No. 2006-2602, filed on Jan. 10, 2006, the content of which is hereby incorporated by reference into this application.

### BACKGROUND OF THE INVENTION

1. Technical Field of the Invention

The present invention relates generally to spark plugs for use in internal combustion engines of motor vehicles and cogeneration systems.

More particularly, the invention relates to a spark plug for an internal combustion engine which has excellent capabilities of detecting ion current and suppressing “inside sparks”.

2. Description of the Related Art

There is known a spark plug for an internal combustion engine which is configured to ignite the air/fuel mixture within a combustion chamber of the engine.

To increase the output and improve the fuel economy of the engine, the spark plug is also configured to detect ion current induced therein, thereby detecting combustion condition in the combustion chamber.

More specifically, during combustion of the air/fuel mixture within the combustion chamber, positive and negative ions are created due to ionization of the air/fuel mixture. The positive and negative ions are absorbed by the corresponding electrodes (i.e., ground and center electrodes) of the spark plug, thereby inducing ion current that flows from the center electrode to the ground electrode. Through detecting the ion current, it is possible to determine the combustion pressure, the occurrence of a misfire, and other parameters and events relating to the combustion.

For example, when knocking occurs in the engine, it affects the waveform of the ion current. Accordingly, it is possible to detect the occurrence of knocking based on the waveform of the ion current.

However, when high voltage is applied to the spark plug, corona discharge may occur in a high electric field strength region between an insulator securing the center electrode and a metal shell retaining the insulator. The corona discharge may induce spike-like noise in the ion current; the waveform of the spike-like noise can be misrecognized as the waveform of ion current indicating occurrence of knocking.

To solve the above problem, Japanese Patent First Publication No. 2000-68031 discloses a spark plug, in which an electrically conductive coat is formed on an area of the outer surface of the insulator near a crimp portion of the metal shell. With the electrically conductive coat, it is possible to lower the electric field strength in the region between the insulator and the metal shell, thereby suppressing corona discharge and preventing occurrence of spark-like noise.

On the other hand, spark plugs with increased axial lengths of threaded portions of metal shells are being used for increasing flexibility in design of engine layout.

As the axial length (i.e., the dimension L4 in FIG. 1) of the threaded portion of the metal shell increases, the axial length of an intermediate portion (i.e., the portion 34 in FIG. 1) of the insulator increases accordingly, as shown in FIG. 11.

Moreover, spark plugs with high heat ranges (i.e. cold-type spark plugs) are being used for increasing the output and improving the fuel economy of the engine.

As the heat range rises, the axial length (i.e., the dimension L5 in FIG. 2) of a leg portion of the insulator decreases, and the axial length of the intermediate portion of the insulator increases accordingly, as shown in FIG. 12.

However, in such long-type spark plugs, a noise having a damped waveform (i.e., the noise waveform 69 in FIG. 6) is found in addition to the above-described spike-like noise.

More specifically, the waveform of the ion current detected in the spark gap between the center and ground electrodes includes, as shown in FIG.3, a residual magnetism noise waveform 60 that appears during the ignition and an ion current waveform 61 that appears immediately following the waveform 60.

When the ion current waveform 61 appears fully, as shown in FIG. 3, it can be determined that the combustion is normal. On the contrary, when the ion current waveform 61 does not fully appear, as shown in FIGS. 4 and 5, it can be determined that the combustion is abnormal (e.g., a misfire has occurred).

However, in a misfire condition, the noise waveform 69 is found which immediately follows the residual magnetism noise waveform 60 and is gradually damped, as shown in FIG.6. The noise waveform 69 is similar to the ion current waveform 61, and it is thus difficult to distinguish the two waveforms.

The cause of the damped waveform noise can be considered as electric charges that accumulate in a space between the outer surface of the insulator and the inner surface of the metal shell. More specifically, when high voltage is applied to the spark plug to ignite the air/fuel mixture, electric charges accumulate in the space; immediately after the ignition, the electric charges flow to the ground electrode, thereby forming the noise.

Furthermore, the obviousness of the damped waveform noise increases with increase in the axial length of the metal shell, i.e., with increase in the axial length of the threaded portion of the metal shell.

To suppress the damped waveform noise, it may be effective to form an electrically conductive coat on the outer surface of the insulator.

However, when the formation range of the electrically conductive coat on the outer surface of the insulator is improperly chosen, it is easy for “inside sparks” to occur during the ignition. The inside sparks here denote sparks which are discharged, instead of across the spark gap between the center and ground electrodes, from the center electrode to the metal shell via the insulator when the insulator is fouled with carbon deposit.

### SUMMARY OF THE INVENTION

The present invention has been made in view of the above-mentioned problems.

It is, therefore, a primary object of the present invention to provide a spark plug for an internal combustion engine which has excellent capabilities of detecting ion current and suppressing inside sparks.

According to the present invention, there is provided a spark plug for an internal combustion engine which includes a tubular metal shell, an insulator, a center electrode, and a ground electrode.

The tubular metal shell has a first and a second end that are opposite to each other. The metal shell also has a first and a second inner shoulder formed on an inner periphery thereof. The first inner shoulder is closer to the first end of the metal shell than the second inner shoulder.

The insulator is retained in the metal shell. The insulator has a length and a bore that extends in a longitudinal direction of the insulator. The insulator also has a first and a second outer shoulder, which are formed on an outer periphery of the insulator and engage respectively with the first and second inner shoulders of the metal shell, and an intermediate portion between the first and second outer shoulders.

The center electrode is secured in the bore of the insulator with an end portion thereof protruding from the insulator.

The ground electrode is fixed to the first end of the metal shell to face the end portion of the center electrode through a spark gap formed therebetween.

In the spark plug:

L1, which is the sum of lengths of the intermediate portion and second outer shoulder of the insulator in the longitudinal direction of the insulator, is greater than or equal to 10 mm;

the intermediate portion of the insulator has an outer surface that includes a first and a second section and has an electrically conductive coat only on the second section, the first and second sections being arranged in the longitudinal direction of the insulator to respectively adjoin surfaces of the first and second outer shoulders of the insulator; and

the first section of the outer surface of the intermediate portion of the insulator, which lies between the second section of the outer surface of the intermediate portion and the surface of the first outer shoulder of the insulator, has a length in the longitudinal direction of the insulator in a range of 1 to 8 mm.

With the above configuration, it is possible for the spark plug to accurately detect ion current induced therein and reliably prevent occurrence of inside sparks.

According to a further implementation of the invention, in the spark plug, the metal shell further has, on an outer periphery thereof, a threaded portion that has a length in the longitudinal direction of the insulator greater than or equal to 25 mm.

With the above configuration, it is possible to increase flexibility in design of engine layout.

In the spark plug, the electrically conductive coat is also formed on the surface of the second outer shoulder of the insulator.

With the above configuration, it is possible to further enhance the ion current detection capability of the spark plug.

In the spark plug, an electrically conductive packing is interposed between the second inner shoulder of the metal shell and the second outer shoulder of the insulator.

With the electrically conductive packing, it is possible to secure excellent ion current detection capability of the spark plug even when the electrically conductive coat is formed with low precision.

In the spark plug, the electrically conductive coat is also formed on an area of an outer surface of the insulator which extends in the longitudinal direction of the insulator from the second outer shoulder of the insulator to the second end of the metal shell.

With the above configuration, it is possible to further enhance the ion current detection capability of the spark plug.

### BRIEF DESCRIPTION OF THE DRAWINGS

The present invention will be understood more fully from the detailed description given hereinafter and from the accompanying drawings of the preferred embodiments of the invention, which, however, should not be taken to limit the invention to the specific embodiments but are for the purpose of explanation and understanding only.

In the accompanying drawings:

FIG. 1 is a partially cross-sectional view showing the overall structure of a spark plug according to the first embodiment of the invention;

FIG. 2 is a side view showing an insulator, with a center electrode secured therein, of the spark plug;

FIG. 3 is a waveform chart illustrating the waveform of ion current induced in the spark plug when the combustion is normal;

FIG. 4 is a waveform chart illustrating the waveform of ion current induced in the spark plug when the combustion is abnormal;

FIG. 5 is a waveform chart illustrating the waveform of ion current induced in the spark plug when the combustion flame is completely off;

FIG. 6 is a waveform chart illustrating the waveform of a noise induced in the spark plug;

FIG. 7 is a graphical representation showing the relationship between a dimensional parameter L1 and the amount of the noise in the spark plug;

FIG. 8 is a graphical representation showing the relationship between a dimensional parameter L2 and the amount of the noise when the spark plug is of a normally-reach type;

FIG. 9 is a graphical representation showing the relationship between the dimensional parameter L2 and the amount of the noise when the spark plug is a long-reach type;

FIG. 10 is a side view showing an insulator, with a center electrode secured therein, of a spark plug according to the second embodiment of the invention;

FIG. 11 is a graphical representation showing the relationship between the axial length of a threaded portion of the metal shell and the axial length of an intermediate portion of the insulator in spark plugs; and

FIG. 12 is a graphical representation showing the relationship between the axial length of a leg portion of the insulator and the axial length of the intermediate portion of the insulator in spark plugs.

### DESCRIPTION OF THE PREFERRED EMBODIMENTS

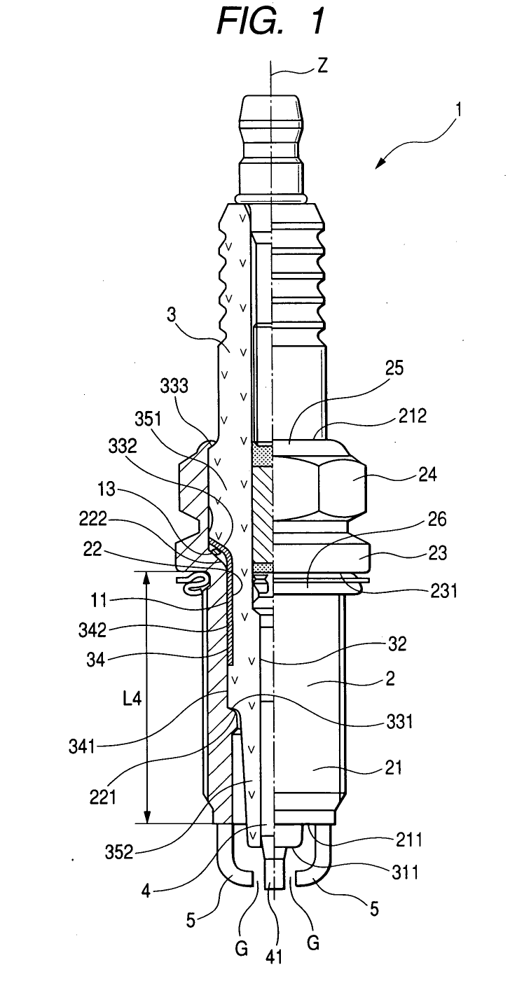

The preferred embodiments of the present invention will be described hereinafter with reference to FIGS. 1-10.

It should be noted that, for the sake of clarity and understanding, identical components having identical functions in different embodiments of the invention have been marked, where possible, with the same reference numerals in each of the figures.

### First Embodiment

FIG. 1 shows the overall structure of a spark plug 1 according to the first embodiment of the invention.

The spark plug 1 is designed for use in an internal combustion engine of a motor vehicle or a cogeneration system. Specifically, the spark plug 1 is designed to perform two different functions in the engine. One function is to ignite the air/fuel mixture within a combustion chamber of the engine; the other is to induce and detect ion current within the combustion chamber of the engine.

As shown in FIG. 1, the spark plug 1 includes a metal shell 2, an insulator 3, a cylindrical center electrode 4, and a pair of ground electrodes 5.

The metal shell 2 has a first end 211 and a second 212, which are opposite to each other in an axial direction Z of the spark plug 1.

It should be noted that in the present embodiment, the axial direction Z of the spark plug 1 coincides with longitudinal directions of the metal shell 2, insulator 3, and center electrode 5.

The metal shell 2 also has a threaded portion 21 on an outer periphery thereof and a through-bore 22 that extends in the axial direction Z of the spark plug 1. In other words, the metal shell 2 has a tubular shape.

In the present embodiment, the metal shell 2 further has a first inner shoulder 221 and a second inner shoulder 222 that are formed on an inner periphery of the metal shell 2. The first inner shoulder 221 is closer to the first end 211 of the metal shell 2 than the second inner shoulder 222.

The metal shell 2 further has a flange portion 23, a hexagonal head portion 24, and a crimp portion 25. Moreover, between the flange portion 23 and the threaded portion 21, there is provided a gasket 26. The hexagonal head portion 24 is provided for wrenching the spark plug 1 into the combustion chamber. The crimp portion 25 is formed by crimping the second end 212 of the metal shell 2 onto the insulator 2.

The insulator 3 is retained in the through-bore 22 of the metal shell 2. The insulator 3 has formed therein a central through-bore 32 that extends in the axial direction Z of the spark plug 1.

The insulator 3 also has a first outer shoulder 331, a second outer shoulder 332, and an intermediate portion 34 between the first and second outer shoulders 331 and 332.

The first and second outer shoulders 331 and 332 are formed on an outer periphery of the insulator 3 and engage respectively with the first and second inner shoulders 221 and 222 of the metal shell 2. More specifically, in the present embodiment, the first outer shoulder 331 is directly disposed on the first inner shoulder 221, while the second outer shoulder 332 is disposed, via an electrically conductive packing 13, on the second inner shoulder 222.

The intermediate portion 34 has an outer surface that includes a first annular section 341 and a second annular section 342, which are arranged in the axial direction Z of the spark plug 1 to respectively adjoin surfaces of the first and second outer shoulders 331 and 332.

In the present embodiment, an electrically conductive coat 11 is formed only on the second section 342 of the outer surface of the intermediate portion 34 and the surface of the second outer shoulder 332.

The electrically conductive coat 11 is made, for example, of platinum, silver, palladium, gold, tungsten, and molybdenum. Among those metal materials, platinum is particularly preferable in terms of durability and electrical conductivity. Silver is also preferable in terms of cost. The electrically conductive coat 11 is formed by applying a paste made of the above metal materials on the second section 342 of the outer surface of the intermediate portion 34 and the surface of the second outer shoulder 332 and fire gilding the paste thereon through firing the insulator 3 with the paste.

The insulator 3 further has a third outer shoulder 333, on which the crimp portion 25 of the metal shell 2 is formed, and a large diameter portion 351 provided between the second and third outer shoulders 332 and 333. Furthermore, the insulator 3 has a leg portion 352 that is provided between the first outer shoulder 331 and a tip end 311 of the insulator 3 and tapers in the axial direction Z of the spark plug 1 toward the tip end 311.

The center electrode 4 is secured in the central through-bore 32 of the insulator 3. The center electrode 4 has an end portion 41 that protrudes from the tip end 311 of the insulator 3.

Each of the ground electrodes 5 has one end joined to the first end 211 of the metal shell 2 and the other end that faces the side surface of the end portion 41 of the center electrode 4 through a spark gap G formed therebetween.

It should be noted that the spark plug 1 may have a different number of ground electrodes 5, for example one or three, and the ground electrodes 5 may be arranged to face the end surface of the end portion 41 of the center electrode 4 to form the spark gap G therebetween.

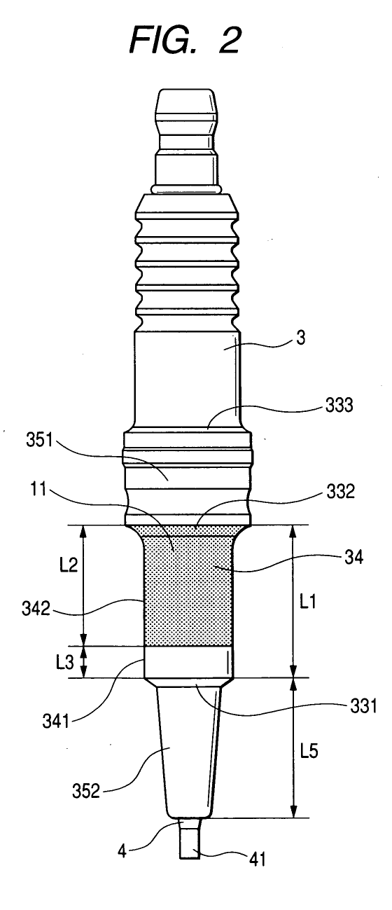

After having described the overall structure of the spark plug 1, the following dimensional parameters, which are critical to the ion current detection and inside spark suppression capabilities of the spark plug 1, will be specified with reference to FIGS. 1 and 2.

L1, which represents the sum of axial lengths of the intermediate portion 34 and second outer shoulder 332 of the insulator 3, is greater than or equal to 10 mm.

L3, which represents the axial length of the first section 341 of the outer surface of the intermediate portion 34 of the insulator 3, is in the range of 1 to 8 mm. As described previously, the first section 341 has no electrically conductive coat 11 thereon.

An axial length L4 of the threaded portion 21 of the metal shell 2, which represents the distance between the first end 211 of the metal shell 2 and an end 231 of the flange portion 23 in the axial direction Z of the spark plug 1, is greater than or equal to 25 mm.

In addition, L2, which represents the sum of axial lengths of the second section 342 of the outer surface of the intermediate portion 34 and the second outer shoulder 332 of the insulator 3, is equal to (L1-L3).

The above-described spark plug 1 according to the present embodiment has the following advantages.

In the spark plug 1, L1 is greater than or equal to 10 mm, and the second section 342 of the outer surface of the intermediate portion 34 of the insulator 3 is covered with the electrically conductive coat 11.

With the above configuration, it is possible to accurately detect ion current induced in the spark plug 1, thereby accurately detecting combustion condition in the combustion chamber.

More specifically, in the spark plug 1, ion current will be induced immediately after ignition, which flows from the center electrode 4 to the ground electrodes 5.

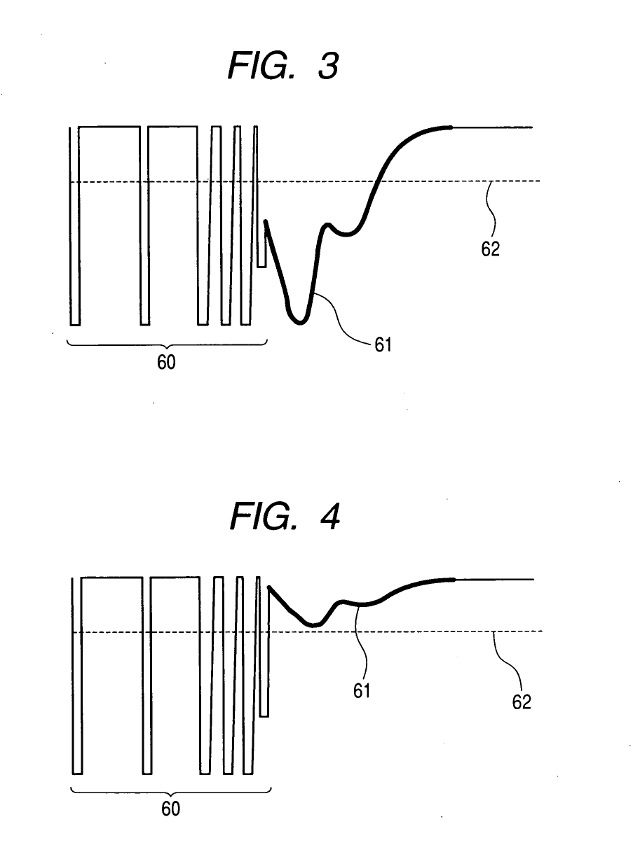

As described previously, referring to FIG. 3, the waveform 61 of the ion current appears immediately following the residual magnetism noise waveform 60 that appears during the ignition.

When the waveform 61 of the ion current appears fully to exceed a predetermined threshold 62 (i.e., when the waveform 61 appears below a dashed horizontal line representing the threshold 62 in FIG. 3), it can be determined that the combustion is normal.

When the ion current waveform 61 does not appear fully so that it cannot exceed the threshold 62, as shown in FIG. 4, it can be determined that the combustion is abnormal.

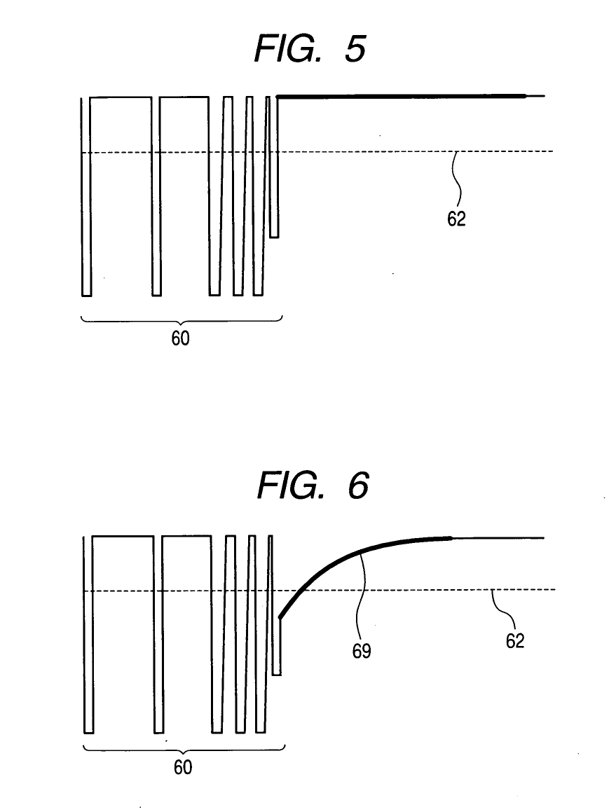

Further, when there is no ion current waveform 61 appearing after the residual magnetism noise waveform 60, as shown in FIG. 5, it can be determined that the combustion flame is completely off.

On the other hand, if there is no electrically conductive coat 11 formed on the outer surface of the intermediate portion 34 of the insulator 3, a noise having a damped waveform 69 as shown in FIG. 6 would be induced between the center and ground electrodes 4 and 5 immediately after the ignition, due to L1 being greater than or equal to 10 mm.

More specifically, the cause of the damped waveform noise can be considered as electric charges that accumulate in the space between the outer surface of the intermediate portion 34 of the insulator 3 and the inner surface of the metal shell 2 during the ignition and flow to the ground electrodes 5 immediately after the ignition.

When L1 is greater than or equal to 10 mm, the amount of the electric charges accumulating in the space is accordingly large.

Thus, without the electrically conductive coat 11, the large amount of electric charges would form the damped waveform noise in the spark plug 1.

As shown in FIG. 6, the damped waveform 69 of the noise also appears immediately following the residual magnetism noise waveform 60, and thus it may be misrecognized as the ion current waveform 61. Accordingly, when the damped waveform 69 exceeds the threshold 62, it may be erroneously determined that the ion current waveform 61 exceeds the threshold 62. Consequently, it may be erroneously determined that the combustion is normal even though a misfire has occurred.

However, in the spark plug 1 according to the present embodiment, the second section 342 of the outer surface of the intermediate portion 34 of the insulator 3 is covered with the electrically conductive coat 11 as described above.

Accordingly, it is possible to allow electric charges existing in the space between the outer surface of the intermediate portion 34 of the insulator 3 and the inner surface of the metal shell 2 to escape to the metal shell 2, thereby preventing the electric charges from accumulating in the space.

Consequently, it becomes possible to prevent the damped waveform noise from occurring in the spark plug 1, thus ensuring excellent ion current detection capability of the spark plug 1.

In the spark plug 1, the first section 341 of the outer surface of the intermediate portion 34 of the insulator 3 has the axial length L3 in the range of 1 to 8 mm.

With the above configuration, it is possible to secure a sufficiently long surface distance between the center electrode 4 and the electrically conductive coat 11, thereby reliably preventing inside sparks from occurring.

At the same time, it is also possible to allow L2 (i.e., L1-L3) to be sufficiently long, thus allowing the electrically conductive coat 11 to function well to reliably prevent the damped waveform noise from occurring in the spark plug 1.

Accordingly, the spark plug 1 according to the present embodiment has excellent capabilities of detecting ion current and suppressing inside sparks.

In the spark plug 1, the threaded portion 21 of the metal shell 2 has the axial length L4 greater than or equal to 25 mm.

With the above configuration, it is possible to increase flexibility in design of engine layout.

Additionally, the damped waveform noise may be easily induced in spark plugs having such a large L4 and no electrically conductive coat 11 on the outer surface of the insulator 3. In comparison, in the spark plug 1, it is possible to reliably suppress the damped waveform noise even with such a large L4.

In the spark plug 1, the surface of the second outer shoulder 332 is also covered with the electrically conductive coat 11.

With the above configuration, electric charges existing in the space between the outer surface of the insulator 3 and the inner surface of the metal shell 2 are allowed to more easily escape to the metal shell 2.

Consequently, it becomes possible to more reliably prevent the damped waveform noise from occurring in the spark plug 1, thus enhancing the ion current detection capability of the spark plug 1.

In the spark plug 1, there is interposed the electrically conductive packing 13 between the second inner shoulder 222 of the metal shell 2 and the second outer shoulder 332 of the insulator 3.

With the electrically conductive packing 13, it is possible to allow electric charges existing in the space between the outer surface of the insulator 3 and the inner surface of the metal shell 2 to easily escape to the metal shell 2 even when the electrically conductive coat 11 is formed with low precision.

In the spark plug 1, the electrically conductive coat 11 is formed only on the second section 342 of the outer surface of the intermediate portion 34 and the surface of the second outer shoulder 332 of the insulator 3. Thus, the outer surface of that portion of the insulator 3 which protrudes from the crimp portion 25 of the metal shell 2 is not covered with the electrically conductive coat 11.

With the above formation, it is possible to secure sufficient insulation between the crimp portion 25 of the metal shell 2 and an ignition coil (not shown) to be mounted to a base end of the spark plug 1, thereby reliably preventing flashover from occurring therebetween.

The above-specified ranges of L1 and L3 have been determined through the experiments to be described below.

### Experiment 1

This experiment was conducted to determine the effect of L1 on the amount of the damped waveform noise that occurs in a spark plug without the electrically conductive coat 11.

All sample spark plugs tested in the experiment had no electrically conductive coat 11 on the outer surface of the insulator 3.

Moreover, four different axial lengths L5 of the insulator leg portion 352 were used for the sample spark plugs, i.e., L5=A (high heat range, cold type), L5=A+2 mm, L5=A+4.5 mm, and L5=A+6.5 mm (low heat range, hot type). Hear, A is a constant value in mm.

Further, for the sample spark plugs of L5=A, two different L1 of 22 mm and 14.5 mm were used; for the sample spark plugs of L5=A+2 mm, two different L1 of 20 mm and 12.5 mm were used.

Each of the sample spark plugs was tested to measure the amount of the damped waveform noise occurring therein.

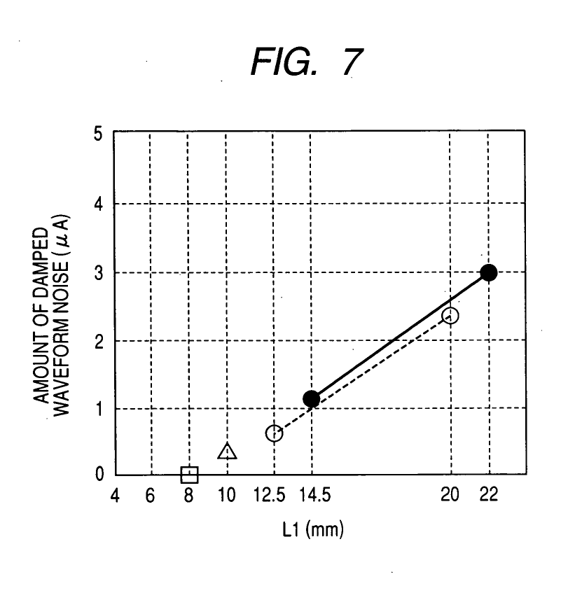

FIG. 7 shows the test results, where the plots of “” indicate the results with the sample spark plugs of L5=A, the plots of “◯” indicate the results with the sample spark plugs of L5=A+2 mm, the plot of “Δ” indicates the results with the sample spark plugs of L5=A+4.5 mm, and the plot of “□” indicates the results with the sample spark plugs of L5=A+6.5 mm.

As seen from FIG. 7, when L1 was 8 mm, no damped waveform noise occurred. However, when L1 increased to 10 mm, the damped waveform noise begun to occur, and the amount of the damped waveform noise increased with increase in L1.

Accordingly, it can be seen from the above results that it is necessary to apply the present invention especially to spark plugs having L1 greater than or equal to 10 mm.

In addition, the damped waveform noise occurs in spark plugs of both the cold type (high heat range) and the hot type (low heat range). However, the amount of the damped waveform noise in the cold type spark plugs is somewhat greater than that in the hot type spark plugs.

### Experiment 2

This experiment was conducted to determine the effect of L2 on the amount of the damped waveform noise that occurs in a normally-reach type spark plug. Here, the normally-reach type denotes a spark plug type with L4 of 19 mm.

All sample spark plugs tested in the experiment were of the normally-reach type; L2 was varied for the sample spark plugs.

Moreover, three different L1 were used for the sample spark plugs, i.e., L1=14.5 mm, L1=12.5 mm, and L1=10 mm.

Furthermore, in each of the sample spark plugs, the electrically conductive coat 11 is formed only on the second section 342 of the outer surface of the intermediate portion 34 and the surface of the second outer shoulder 332 of the insulator 3.

Each of the sample spark plugs was tested to measure the amount of the damped waveform noise occurring therein.

FIG. 8 shows the test results, where the plots of “” indicate the results with the sample spark plugs of L1=14.5 mm, the plots of a“◯” indicate the results with the sample spark plugs of L1=12.5 mm, and the plots of “Δ” indicate the results with the sample spark plugs of L1=10 mm.

As seen from FIG. 8, it was possible to prevent the damped waveform noise from occurring when L1=14.5 mm and L2≧6 mm, when L1=12.5 mm and L2≧4 mm, and when L1=10 mm and L2≧2 mm.

Accordingly, it can be seen from the above results that for normally-reach type spark plugs, it is possible to prevent the damped waveform noise from occurring to the extent that L1 is greater than or equal to 10 mm and L3 is less than or equal to 8 mm.

### Experiment 3

This experiment was conducted to determine the effect of L2 on the amount of the damped waveform noise that occurs in a long-reach type spark plug. Here, the long-reach type denotes a spark plug type with L4 of 26.5 mm.

All sample spark plugs tested in the experiment were of the long-reach type; L2 was varied for the sample spark plugs.

Moreover, two different L1 were used for the sample spark plugs, i.e., L1=22 mm, and L1=20 mm.

Furthermore, in each of the sample spark plugs, the electrically conductive coat 11 is formed only on the second section 342 of the outer surface of the intermediate portion 34 and the surface of the second outer shoulder 332 of the insulator 3.

Each of the sample spark plugs was tested to measure the amount of the damped waveform noise occurring therein.

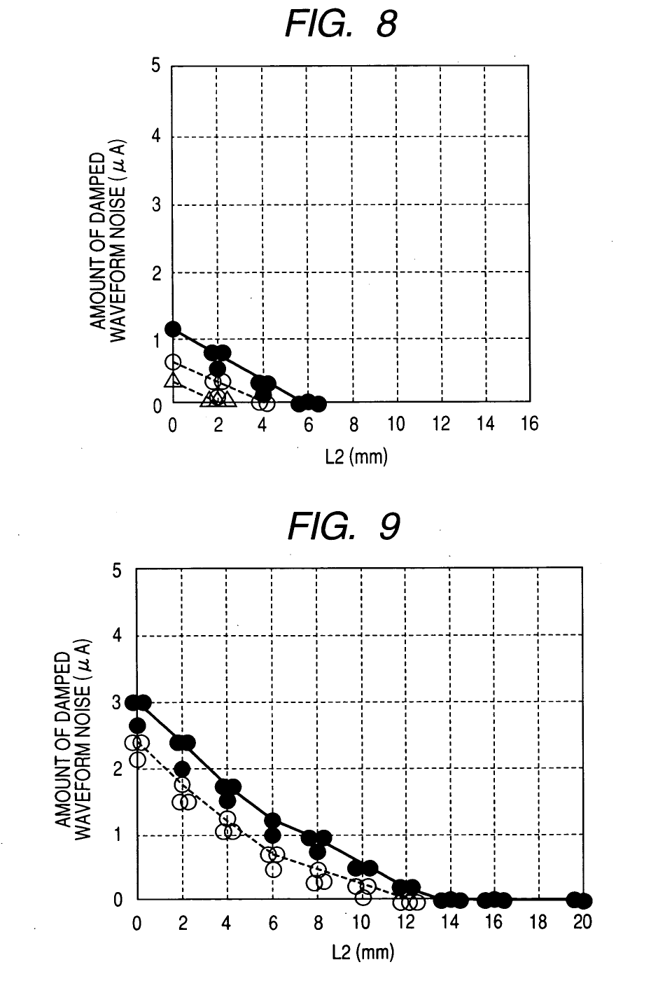

FIG. 9 shows the test results, where the plots of “” indicate the results with the sample spark plugs of L1=22 mm, and the plots of “◯” indicate the results with the sample spark plugs of L1=20 mm.

As seen from FIG. 9, it was possible to prevent the damped waveform noise from occurring when L1=22 mm and L2≧14 mm and when L1=20 mm and L2 ≧12mm.

Accordingly, it can be seen from the above results that for long-reach type spark plugs, it is possible to prevent the damped waveform noise from occurring to the extent that L1 is greater than or equal to 10 mm and L3 is less than or equal to 8 mm.

### Second Embodiment

This embodiment illustrates a spark plug 1A which has a structure almost identical to that of the spark plug 1 according to the previous embodiment. Accordingly, only the difference in structure between the spark plugs 1 and 1A is to be described hereinafter.

As described previously, in the spark plug 1, only the second section 342 of the outer surface of the intermediate portion 34 and the surface of the second outer shoulder 332 of the insulator 3 is covered with the electrically conductive coat 11.

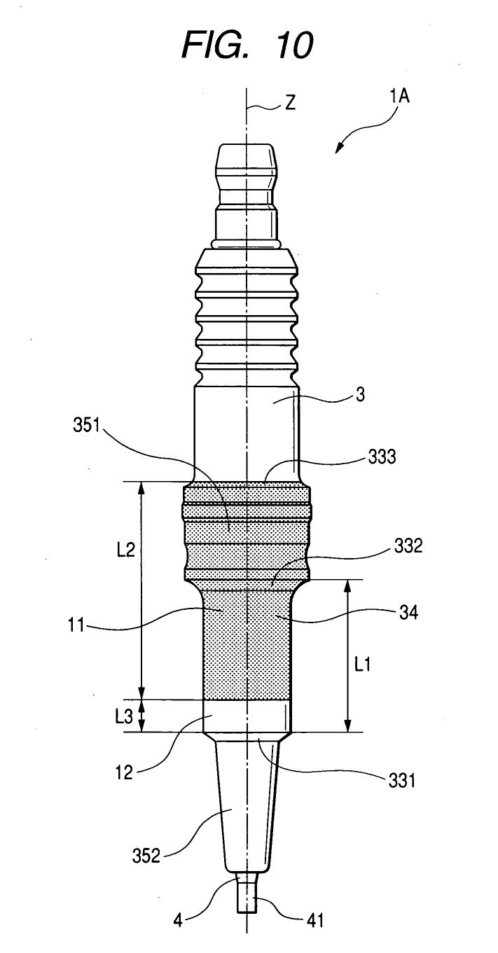

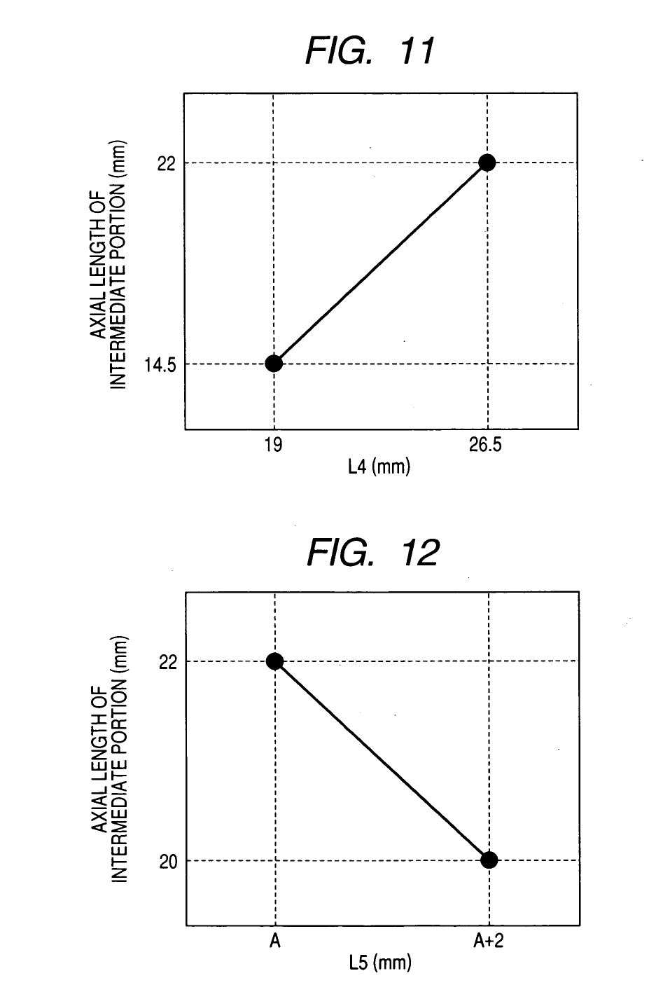

In comparison, in the spark plug 1A, the electrically conductive coat 11 is formed, as shown in FIG. 10, not only on the second section 342 of the outer surface of the intermediate portion 34 and the surface of the second outer shoulder 332 of the insulator 3, but also on the outer surface of the large diameter portion 351 and the surface of the third outer shoulder 333 of the insulator 3.

In other words, in the spark plug 1A, an area of the outer surface of the insulator 3, which extends in the axial direction Z of the spark plug 1A from the second outer shoulder 332 of the insulator 3 to the second end 212 of the metal shell 2, is also covered with the electrically conductive coat 11.

With the above formation, the total area of the electrically conductive coat 11 is increased, thus more reliably preventing the damped waveform noise from occurring in the spark plug 1A.

Further, since the electrically conductive coat 11 is in intimate contact with the crimp portion 25 of the metal shell 2, it is possible to further reliably prevent the damped waveform noise from occurring in the spark plug 1A.

Furthermore, with the intimate contact between the electrically conductive coat 11 and the crimp portion 25 of the metal shell 2, it is not necessary to dispose the electrically conductive packing 13 between the second inner shoulder 222 of the metal shell 2 and the second outer shoulder 332 of the insulator 3.

In addition, the spark plug 1A according to the present embodiment also has the advantages of the spark plug 1 described in the previous embodiment.

While the above particular embodiments of the invention have been shown and described, it will be understood by those who practice the invention and those skilled in the art that various modifications, changes, and improvements may be made to the invention without departing from the spirit of the disclosed concept.

Such modifications, changes, and improvements within the skill of the art are intended to be covered by the appended claims.

What is claimed is:

1. A spark plug for an internal combustion engine comprising:
a tubular metal shell having a first and a second end that are opposite to each other, the metal shell also having a first and a second inner shoulder formed on an inner periphery thereof, the first inner shoulder being closer to the first end of the metal shell than the second inner shoulder;
an insulator retained in the metal shell, the insulator having a length and a bore that extends in a longitudinal direction of the insulator, the insulator also having a first and a second outer shoulder, which are formed on an outer periphery of the insulator and engage respectively with the first and second inner shoulders of the metal shell, and an intermediate portion between the first and second outer shoulders;
a center electrode secured in the bore of the insulator with an end portion thereof protruding from the insulator; and
a ground electrode fixed to the first end of the metal shell to face the end portion of the center electrode through a spark gap formed therebetween,
wherein
L1, which is the sum of lengths of the intermediate portion and second outer shoulder of the insulator in the longitudinal direction of the insulator, is greater than or equal to 10 mm,
the intermediate portion of the insulator has an outer surface that includes a first and a second section and has an electrically conductive coat only on the second section, the first and second sections being arranged in the longitudinal direction of the insulator to respectively adjoin surfaces of the first and second outer shoulders of the insulator, and
the first section of the outer surface of the intermediate portion of the insulator, which lies between the second section of the outer surface of the intermediate portion and the surface of the first outer shoulder of the insulator, has a length in the longitudinal direction of the insulator in a range of 1 to 8 mm.

2. The spark plug as set forth in claim 1, wherein the metal shell further has, on an outer periphery thereof, a threaded portion that has a length in the longitudinal direction of the insulator greater than or equal to 25 mm.

3. The spark plug as set forth in claim 1, wherein the electrically conductive coat is also formed on the surface of the second outer shoulder of the insulator.

4. The spark plug as set forth in claim 3, further comprising an electrically conductive packing that is interposed between the second inner shoulder of the metal shell and the second outer shoulder of the insulator.

5. The spark plug as set forth in claim 3, wherein the electrically conductive coat is also formed on an area of an outer surface of the insulator which extends in the longitudinal direction of the insulator from the second outer shoulder of the insulator to the second end of the metal shell.
